(19) United States
(12) Patent Application Publication
(10) Pub. No.: US 2013/0232091 A1
(43) Pub. Date: Sep. 5, 2013

(54) Systems and Methods for a Maximum Product Position Risk Check

(71) Applicant: TRADING TECHNOLOGIES INTERNATIONAL, INC., Chicago, IL (US)

(72) Inventors: Andrea C. Garlanger, Chicago, IL (US); Patricia A. Messina, Chicago, IL (US); Bharat Mittal, Schaumburg, IL (US)

(73) Assignee: Trading Technologies International, Inc., Chicago, IL (US)

(21) Appl. No.: 13/866,753

(22) Filed: Apr. 19, 2013

Related U.S. Application Data
(63) Continuation of application No. 13/077,585, filed on Mar. 31, 2011, now abandoned.

(51) Int. Cl. G06Q 40/06

(52) U.S. Cl. CPC G06Q 40/06
USPC 705/36 R

(57) ABSTRACT

Various systems and methods are described herein for product level risk checks. The product level risk checks are used to either allow or prevent a trading strategy to proceed. When a trading strategy is initiated, positions created by various contracts for the trading strategy are grouped based on their association with the same product. Then, an offsetting logic is applied at a contract level to offset at least some positions created for the same contract by various orders across the orders of the trading strategy.

### FIELD OF INVENTION

The present patent document is directed towards electronic trading. More particularly, the present patent document relates to tools and features for risk management of a trading strategy.

### BACKGROUND

An electronic trading system generally includes one or more trading devices in communication with an electronic exchange (or multiple electronic exchanges). By way of illustration, an electronic exchange receives trade orders from client devices, including user trading terminals, gateways or servers that may be collocated with the electronic exchange. Upon receiving a trade order, the electronic exchange enters the trade order into an exchange order book and attempts to match quantity of the trade order with one or more contra-side orders. A sell order is contra-side to a buy order with the same price. Similarly, a buy order is contra-side to a sell order with the same price.

Many traders trade only one tradeable object at a time. For example, a trader might trade June 2011 corn contract. That is, the trader may be willing to buy or sell the corn contract. It is also common for traders to trade more than one tradeable object in a trading strategy, such as a spread trading strategy. A trading strategy may involve placing at least one order (“a quoting order”) at an electronic exchange, and then offsetting a fill (either a partial or complete fill of the quoting order) with a hedge order in one or more tradeable objects. For example, a trader may buy multiple different tradeable objects, sell multiple different tradeable objects, or buy and sell a combination of different tradeable objects as part of a spread trading strategy.

Spreading is a trading strategy that traders often use to hedge risk. For example, to achieve a spread, a trader typically works orders in two or more different markets, with each market corresponding to a leg of the spread. Currently, there are two ways a trader could trade a spread. According to one method, a trader may trade an exchange-provided spread contract that guarantees the spread transaction will be completed. According to the second method, traders can use automated spread trading tools that allow them to create their own spreads, often referred to as synthetic spreads. While a trader who trades spreads using automated spread trading tools may sometimes face problems of getting legged up, i.e., not completing the spread because one or more legs of the spread don't get filled at desired prices, the automated spread trading tools generally allow the trader to be more aggressive and potentially result in higher profits for the trader.

A spread trading strategy may be configured to include calendar month contracts. For example, a trader could spread trade June 2011 corn contract and December 2011 corn contract, or vice versa. In this example, the June/December spread has two legs. The June 2011 corn contract makes one leg, while the December 2011 corn contract makes the second leg. In this example, each leg corresponds to a calendar month contract, which can be referred to as an outright market. However, a trading strategy may be created based on relationships other than calendar months. For example, a leg of a spread trading strategy may include an exchange-provided spread contract in one or more of its legs.

Users of electronic trading systems often employ risk management techniques to manage or limit risk associated with electronic trading. However, current risk management techniques have disadvantages that may result in many unfavorable outcomes including, for example, too much risk being taken out of the available risk account balance. This may preclude a trader from submitting new orders based on the remaining risk balance.

### SUMMARY

Various embodiments that are described herein include systems, methods, and computer readable media for pre-execution risk management in an electronic trading environment. According to the embodiments described herein, a maximum product position is determined for a trading strategy. The maximum product position is then used to determine whether an order for the trading strategy can be sent to an electronic exchange.

Example methods described herein for determining a maximum product position are applied to an attempted order to buy or sell a trading strategy that includes at least two legs. The first leg of the trading strategy corresponds to an exchange-provided spread contract to buy or sell a spread between a first contract and a second contract, and the second leg of the trading strategy corresponds to one of the contracts of the exchange-provided spread, such as the first contract. According to one embodiment, the first and second contracts may correspond to different calendar month contracts of the same product.

One example method for determining a maximum product position in relation to the attempted order to buy or sell the trading strategy described above includes determining a first position to buy or sell a first quantity of the first contract in the first leg of the trading strategy, and a second position to sell or buy a second quantity of the first contract in the second leg of the trading strategy. For example, the first position may include a long position created when the first contract is being bought as part of the exchange-provided spread in the first leg of the trading strategy, and the second position may include a short position created when the first contract is being sold in the second leg of the trading strategy. In such an embodiment, it may be determined that the second position offsets the first position created in the first leg of the trading strategy, and the method may further include offsetting the first position with the second position to determine a modified first position in the first contract. As the trading strategy includes the second contract that corresponds to the same product as the first contract, the method further includes determining a third position to buy or sell the second contract in the first leg of the trading strategy. The first modified position and the third position may then be used to determine a maximum product position for the trading strategy. The maximum product positions may include a maximum long product position and a maximum short product position.

The maximum product position may then be compared to a product position limit to determine if the attempted order for the trading strategy can be approved for execution. If the product position limit is not exceeded, the trading strategy is approved and one or more orders may be sent to an electronic exchange for the trading strategy. If the product position limit is exceeded, the trading strategy is rejected and no orders may be sent to an electronic exchange for the trading strategy.

Reference herein to “one embodiment,” “an embodiment,” or “an example embodiment,” means that a particular feature, structure, or characteristic described in connection with the embodiment can be included in at least one embodiment of the invention. The appearances of these phrases in various places of the specification are not necessarily all referring to the same embodiment, nor are separate or alternative embodiments mutually exclusive. Instead, various embodiments described herein may be combined with other embodiments. The individual embodiments, as well as combinations thereof, are all intended to be within the scope of this patent document.

### BRIEF DESCRIPTION OF THE DRAWINGS

Example embodiments are described herein with reference to the following drawings.

FIG. 1 is a block diagram that illustrates an example trading strategy;

FIG. 2 illustrates a spread position risk system; and

FIG. 3 illustrates a limit module.

The foregoing will be better understood when read in conjunction with the drawings which show certain embodiments of the present invention. The drawings are for the purpose of illustrating certain embodiments, but it should be understood that the present invention is not limited to the arrangements and instrumentality shown in the drawings.

### DETAILED DESCRIPTION

Various embodiments provided herein include systems, methods, and computer readable media for pre-execution risk management using a maximum product position determined for an order to buy or sell a trading strategy.

Pre-execution risk management involves setting one or more parameters to limit financial risk prior to routing an attempted order to an electronic exchange. An attempted order is an order that a user or a trading application is attempting to send to an exchange. When a pre-execution risk application detects an attempted order, it determines whether to allow the attempted order to be sent to the exchange based on one or more risk limits. When an attempted order does not meet one of the specified risk limits, it is rejected and is not routed to the market.

The existing pre-execution risk applications allow risk administrators to set various types of risk limits, including position-based risk limits, such as a net product position limit and a contract position limit. To apply a net product position limit to an attempted order, a risk engine calculates a maximum net product position based on net positions that may be created in calendar month contracts that make up the product in the order. For example, let's assume that an attempted order is detected to buy an exchange provided spread contract (GE Jun10-GE Dec10), with both contracts corresponding to “GE” product. Based on the definition of the exchange-provided spread, a net product position for the attempted order is “0,” as the long position created in ‘GE Jun10” contract is cancelled by the short position created in “GE Dec10” contract. The calculated value is then compared to the net product position limit to determine if the attempted order can be entered to the market.

Similarly, to apply a contract position limit to an attempted order, the risk engine calculates a maximum contract position based on positions that may be created in each contract. For example, using the example attempted order above, a long position of “1” may be determined for “GE Jun10” contract, and a short position of “1” may be determined for “GE Dec10” contract. The calculated values are then compared to the corresponding contact position limit to determine if the attempted order can be entered to the market.

The existing net product position and contract position limits cannot be effectively used to limit a number of spreads in relation to a trading strategy that includes an exchange-provided spread contract in one or more of its leg. To illustrate, let's assume that a risk administrator sets a net product position limit of “30” for “GE” product, and a contract position limit of “30” for each calendar month contract of “GE” product. Let's also assume that the risk administrator wishes to limit a trader to “30” spreads across all calendar month contracts of “GE” product. Let's further assume that an attempted order is detected to buy a trading strategy that includes three exchange-provided spread contracts. The exchange-provided spread contracts are: (1) (GE Mar10-GE Jun10), (2) (GE Sep10-GE Dec10), and (3) (GE Feb10-GE May10). Let's further assume that a desired order quantity for the attempted order is “15.” As each leg of the trading strategy includes an exchange-provided spread with the same quantity of a first contract being bought and a second contract being sold, a maximum net product position for each leg is “0.” For example, referring to (GE Mar10-GE Jun10) spread in the first leg of the trading strategy, a maximum net product position created in the first leg is “0” as the long position created in “GE Mar10” contract is canceled by the short position created in “GE Jun10” contract.

To determine a maximum contract position for an order to buy the trading strategy described above, let's assume that the first leg is a quoting leg, and thus a quoting order is sent in the first leg, and hedge orders are sent in the second and third legs when the quoting order is filled. Based on such a configuration, a maximum contract position created in relation to each calendar month contract is “15.” For example, assuming that all legs are being bought, a maximum long contract position of “15” is determined for “GE Mar10,” “GE Sep10,” and “GE Feb10,” and a maximum short contract position of “15” is determined for “GE Jun10,” “GE Dec10,” and “GE May10.”

Based on the calculated maximum net product position and the maximum contract position, the attempted order would be approved for execution, because neither the preset net product position limit of “30” nor the preset contract position limit of “30” would be exceeded. While none of the preset limits would be exceeded, a trader would be allowed to buy “45” exchange-provided spread contracts across the three legs of the trading strategy. The attempted order would be sent to an electronic exchange even though the risk administrator intended to limit the trader to “30” spreads in “GE” product. Thus, in this example, the existing net product and contract position limits could not be effectively used to control the number of spreads at the product level, i.e., across all calendar month contracts of the same “GE” product.

To overcome the limitations of the existing methods, a maximum long product position limit and a maximum short product position limit may be used. To apply the limits, maximum long and short product positions may be determined for an attempted order by calculating the sum of long positions and the sum of short positions across all calendar month contracts of the same product. Using the example attempted order above, the maximum long product position of “45” would be determined for “GE” product based on the long position of “15” in each of “GE Mar10,” “GE Sep10,” and “GE Feb10” calendar month contracts. Similarly, the maximum short product position of “45” would be determined for “GE” product based on the short position of “15” in each of “GE Jun10,” “GE Dec10” and “GE Mayl0” calendar month contracts. To limit the number of spreads at the product level to “30,” a risk administrator may set a maximum long/short product position limit to “30.” When the calculated maximum long/short product positions of “45” are compared to the maximum long/short product position limit of “30,” the attempted order is rejected as the available product position balance would be exceeded.

There are apparent benefits of using the maximum long/short product position limits in relation to trading strategies such as the one described above. However, the calculations of the maximum long and short product positions using the method described above may not reflect the true risk associated with a trading strategy that includes an exchange-provided spread in one of its legs, and one of the calendar month contracts of the exchange-provided spread in another leg. More specifically, the maximum product positions calculated using the methods described above in relation to such trading strategies may be too high, thus resulting in too much risk balance being allocated from the available risk account balance.

To further illustrate, let's assume an attempted order is detected for a trading strategy that includes an exchange provided spread contract “GE Mar10-GE Jun10” in the first leg, a calendar month contract “GE Mar10” in the second leg, and a calendar month contract “GE Jun10” in the third leg. Let's also assume that the first and third legs are being bought, while the second leg is being sold. Using the minus sign to indicate the second leg being sold, the trading strategy may be represented as:
(GE Mar10−GE Jun10)×(−GE Mar10)×(GE Jun10)
   Let's further assume that all legs of the trading strategy are quoted. To determine a maximum long product position and a maximum short product position, positions created in both “GE Mar10” and “GE Jun10” contracts are first determined based on each quoting order and its hedge orders. For example, when the first leg is quoted, a long position of “1” in “GE Mar 10” contract and a short position of “1” in “GE Jun10” contract are created based on a quoting order in the first leg. When the quoting order is filled, hedge orders are sent in the second and third legs of the trading strategy. Positions created by the hedge orders include a short position of “1” in “GE Mar10” in the second leg and a long position of “1” in “GE Jun10” in the third leg. Table 1 illustrates long and short positions created in each contract in relation to each quoting order and its hedge orders.

TABLE 1

| | GE Mar10 | GE Mar10 | GE Jun10 | GE Jun10 |
|---|---|---|---|---|
| | Long | Short | Long | Short |
| | Position | Position | Position | Position |
| Quoting Order in | 1 | 1 | 1 | 1 |
| Leg 1 & Hedge Orders in | | | | |
| Legs 2 and 3 | | | | |
| Quoting Order in | 1 | 1 | 1 | 1 |
| Leg 2 & Hedge Orders in | | | | |
| Legs 1 and 3 | | | | |
| Quoting Order in | 1 | 1 | 1 | 1 |
| Leg 3 & Hedge Orders in | | | | |
| Legs 1 and 2 | | | | |

To determine a maximum long product position for “GE” product, the long positions created across all calendar month contracts corresponding to “GE” product may be added. Based on the long positions of “3” in both “GE Mar10” and “GE Jun10” contracts, the maximum long product position is “6.” Similarly, the maximum short product position may be determined by adding the short positions created across all calendar month contracts corresponding to “GE” product. Based on the short positions created in “GE Mar10” and “GE Jun10” contracts, the maximum short product position is “6.”

As mentioned above, the calculations of the maximum product positions in relation to some trading strategies such as the one described above may be overly conservative. The example methods described herein solve this problem by applying an offsetting logic to positions created for the same contract across two or more legs of a trading strategy. More specifically, as will be described in greater detail below, the offsetting logic may recognize that positions created in “GE Jun10” contract in the first and third legs of the trading strategy may offset each other, as “GE Jun10” contract is being sold in the first leg and is being bought in the third leg. Similarly, positions created in “GE Mar10” contract in the first and second legs of the trading strategy may offset each other as well, as “GE Mar10” contract is being bought in the first leg and is being sold in the second leg. As will be described in greater detail below, when the offsetting logic is used, the maximum long and short product positions calculated for the trading strategy are both “2.”

According to another example embodiment, when a trading strategy includes more than one exchange-provided spread contract, one or more of such contracts may be excluded from the maximum long and short product position calculations. As will be described in greater detail below, spreads that are excluded are mixed-sign exchange-provided spread contracts (e.g., “Mar-Jun”) that are completely offset by exchange-provided spread contracts in other legs of a trading strategy. For example, assume that a trading strategy is defined as:
(GE Mar10−GE Jun10)×(GE Jun10−GE Sep10)×(GE Sep10−GE Dec10)
   Based on the definition of the trading strategy, (GE Jun10−GE Sep10) spread hedge order may be excluded from the calculations as it is completely offset by “−GE Jun10” in the first leg of the trading strategy and by “GE Sep10” in the third leg of the trading strategy. As will be described in greater detail below, such exchange-provided spread contracts are excluded from calculations of possible spread hedge positions, as they would not increase the maximum long or short product positions for the trading strategy.

As used herein, a “tradeable object” refers to anything that can be traded with a price, a quantity, or both price and quantity. For example, financial products such as various stocks, options, bonds, futures, currency, warrants, funds derivatives, commodities, and collections and/or combinations of these may be tradeable objects. Each product may include various contracts. For example, a futures product may include many contracts having different expiration dates. A tradeable object may be “real” or “synthetic.” A real tradeable object includes products or contracts that are listed by an exchange. A synthetic tradeable object includes products or contracts that are defined by the user and are not listed by an exchange. For example, a synthetic tradeable object may include a combination of real (or synthetic) products such as a synthetic spread. A tradeable object may also include traded events or goods.

### I. Trading Strategy

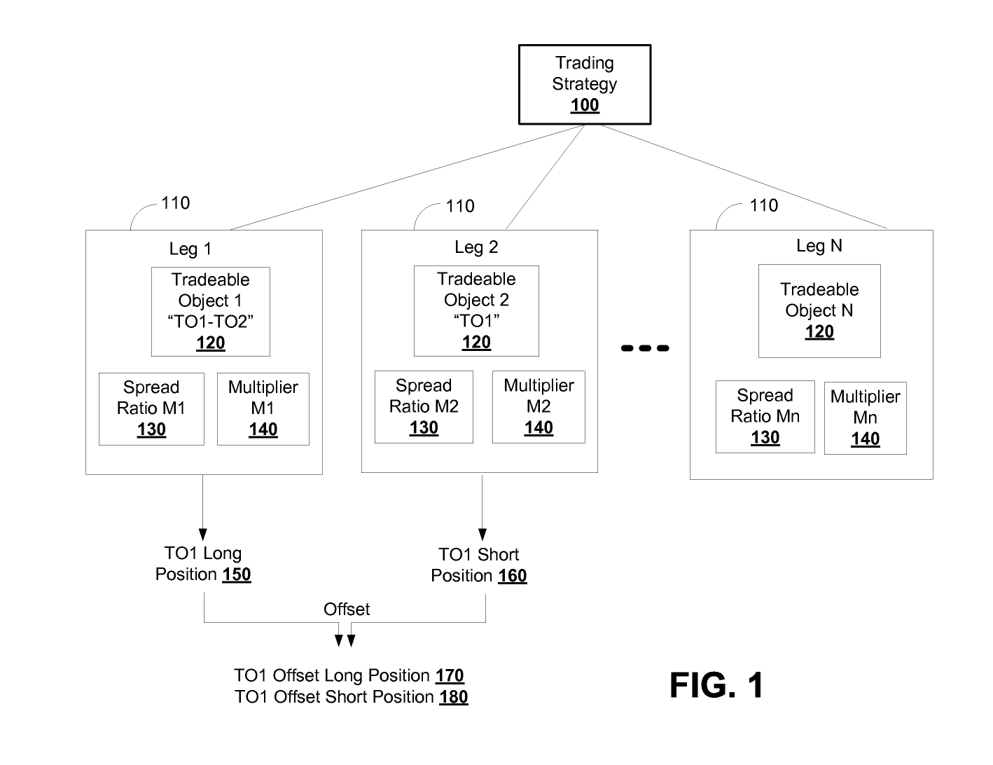

FIG. 1 is a block diagram that illustrates an example trading strategy 100. The trading strategy includes “N” legs 110. As explained above, a leg refers to a tradeable object, such as, for example, a calendar month contract or an exchange-provided spread contract.

A trader may utilize a trading tool to trade according to the trading strategy 100. For example, the trading tool, Autospreader™ provided by Trading Technologies, Inc. of Chicago, Ill., provides a software tool for trading spreads. Autospreader also provides a mechanism for defining a trading strategy. Components of a tool like Autospreader may be implemented on a client side, a server side, or a combination of the client and server sides.

The trading strategy 100 defines the relationship between the tradeable objects 120 for each of the legs 110 using spread ratios 130 and multipliers 140 associated with each of the legs 110. Once defined, the tradeable objects 120 in the trading strategy 100 may be traded together according to the defined relationship.

When the trading strategy 100 is being bought, the definition of the trading strategy specifies which tradeable objects corresponding to each leg should be bought or sold. Similarly, when the trading strategy is being sold, the definition specifies which tradeable objects corresponding to each leg should be bought or sold. For example, a trading strategy may be defined such that buying the trading strategy involves buying a first tradeable object for Leg 1 and selling a second tradeable object for Leg 2. Selling the trading strategy typically involves performing the opposite actions for each leg.

The definition for the trading strategy may also specify a spread ratio associated with each leg of the trading strategy. The spread ratio if often referred to as an order size for the leg. The spread ratio indicates the quantity of each leg in relation to the other legs. For example, a trading strategy may be defined such that buying the trading strategy involves buying a quantity of “2” of a first tradeable object for Leg 1 and selling a quantity of “3” of a second tradeable object in Leg 2. The sign of the spread ratio may be used to indicate whether the leg is to be bought (the spread ratio is positive) or sold (the spread ratio is negative) when buying the trading strategy. In the example above, the spread ratio associated with Leg 1 would be “2,” and the spread ratio associated with Leg 2 would be “−3.” In some instances, the spread ratio may be implied or implicit. For example, the spread ratio for a leg of a trading strategy may not be explicitly specified, but rather implied or defaulted to be “1” or “−1.”

Additionally, the definition of the trading strategy may specify a multiplier associated with each leg of the trading strategy. The multiplier is used to adjust the price of the particular leg for determining the price of the spread. The multiplier for each leg may be the same as the spread ratio. For example, in the example above, the multiplier associated with Leg 1 may be “2” and the multiplier associated with Leg 2 may be “−3,” both of which match the corresponding spread ratio for each leg. Alternatively, the multiplier associated with one or more legs may be different than the corresponding spread ratios for those legs. For example, the values for the multipliers may be selected to convert the prices for the legs into a common currency.

The following discussion assumes that the spread ratio 130 and the multipliers 130 are the same. In the example herein, the trading strategy 100 is a spread trading strategy with two legs 110. Leg 1 is for an exchange-provided spread contract between two tradeable objects “TO1” and “TO2” including two calendar month contracts, with “TO1” being bought and “TO2” being sold. Leg 2 is for the tradeable object “TO1” that matches the calendar month contract in the exchange-provided spread contract of Leg 1. The spread ratios 130 and multipliers 140 associated with Leg 1 and Leg 2 are “1” and “−1,” respectively. The trading strategy 110 may be defined such that when the trading strategy 110 is bought, a quantity of “1” of the exchange-provided spread contract “(TO1-TO2)” is bought, and a quantity of “1” of “TO1” is sold. If the trading strategy is sold, a quantity of “1” of the exchange-provided spread contract “(TO1-TO2)” is sold, and a quantity of “1” of “TO1” is bought.

It should be understood that a user may also define a desired order quantity for the trading strategy. In the example above, the desired order quantity for the trading strategy was “1.” If the desired order quantity is other than “1,” the quantity to be bought or sold in relation to each leg is determined by multiplying the spread ratio by the desired order quantity. For example, assuming that the desired order quantity for the trading strategy above is set to “2,” and the trading strategy is bought, a quantity of “2” of the exchange-provided spread contract would be bought, and a quantity of “2” of “TO1” would be sold.

When a user defines the trading strategy, the user may define which leg should be a quoting leg. As explained above, when a user places an order for the trading strategy, the automated trading tool may automatically place an order, which is often referred to as a quoting order, in the quoting leg of the trading strategy. The other legs may be referred to as hedge legs. The price of the quoting order is based on the best price(s) that an order can be filled in the hedge leg(s). When the quoting order is filled, the automated trading tool may automatically place an order, which is often referred to as a hedge order, in each hedge leg to complete the strategy.

A trading strategy may be quoted in multiple legs. In such situations, each quoted leg leans on the other legs, even if the other legs are also quoting legs. For example, when both Leg 1 and Leg 2 are quoting, a quoting order may be placed in Leg 1 based on market conditions in Leg 2 which is a hedge leg for the quoting order in Leg 1. Additionally, a quoting order would also be placed in Leg 2 based on market conditions in Leg 1 which is a hedge leg for the quoting order in Leg 2. When one of the quoted legs is filled, the orders in the other quoted legs are typically cancelled and then appropriate hedge orders are placed based on prices that the filled leg was based on.

The methods for determining a maximum long product position and a maximum short product position described in greater detail below may be used in relation to the trading strategy shown in FIG. 1. To illustrate the calculations, let's assume that “TO1” and “TO2” are calendar month contracts corresponding to the same product. To determine a maximum long product position according to the methods that will be described in greater detail below, long positions created in relation to calendar month contracts of the same product may be added across all orders (quoting orders and hedge orders) of the trading strategy. However, if a calendar month contract appears in more than one leg of the trading strategy, while being bought in one leg of a quoting order and sold in another leg of a hedge order, an offsetting logic is used to determine an offset long position for such a contract. Similar methods may be used to determine a maximum short product position, where a long position created in one leg may be used to offset a short position created in another leg of the trading strategy for the same contract.

Based on the definition of the trading strategy described herein, “TO1” is bought in Leg 1 in relation to the exchange-provided spread contract, and is sold as a calendar month contract in Leg 2. Thus, a long position 150 may be created for TO1 in Leg 1, while a short position 160 may be created for TO1 in Leg 2. If both legs of the trading strategy are quoted, the long position 150 for TO1 may be created by a quoting order and a hedge order in Leg 1. Similarly, the short position 160 for TO1 may be created by a quoting order and a hedge order in Leg 2. As will be described in greater detail below, an offsetting logic may be used to determine an offset long position 170 and an offset short position 180 for T02. For example, when determining an offset long position 170, a long position created by a quoting order in Leg 1 may be offset by a short position created by a hedge order in Leg 2. Similarly, when determining an offset short position 170, a short position created by a quoting order in Leg 2 may be offset by a long position created by a hedge order in Leg 1. The offset positions 170 and 180 are then used to determine a maximum long/short product position for the trading strategy.

### II. Maximum Product Position Risk-Check System

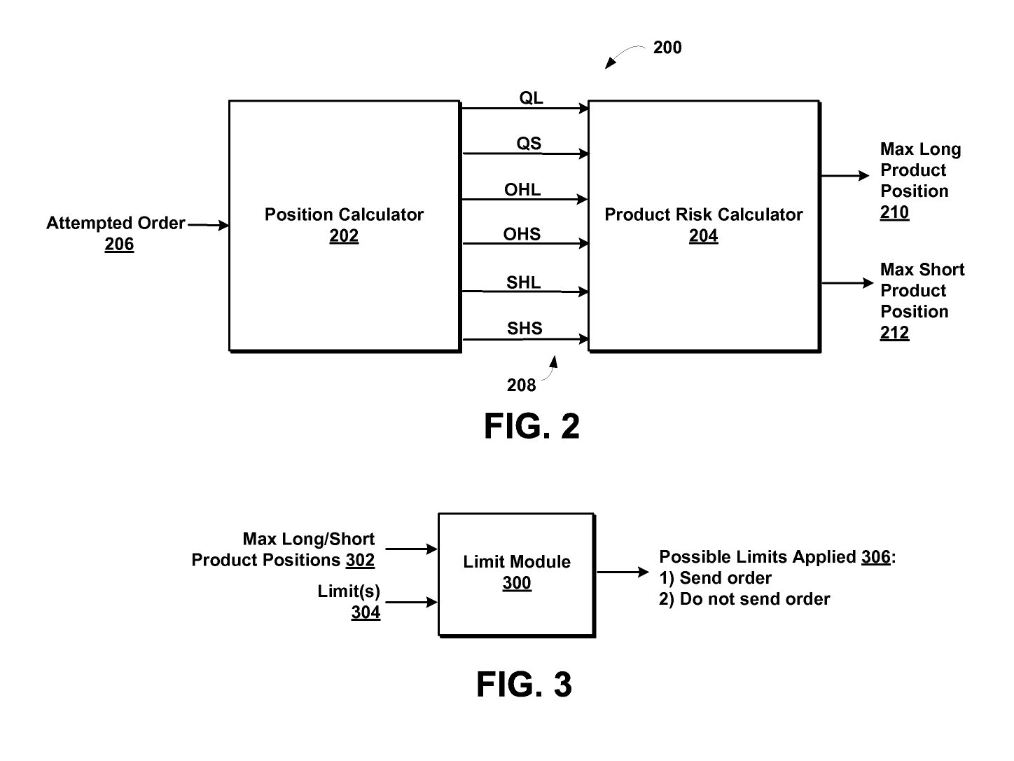

FIG. 2 shows a risk calculation system 200 for determining a maximum long product position and a maximum short product position for an attempted order to buy or sell a trading strategy.

Risk calculation system 200 includes a position calculator 202 and a product risk calculator 204. System 200 may be a stand-alone unit that can work with other sections of a trading program, or the same module might be able to perform the same task in another program as well. Alternatively, system 200 may be part of an integrated architecture, in which no particular divisions exist between components. It should be understood that various components of system 200 may reside on one or more computing devices, such as a personal computer, workstation with a single or multi-core processor, server with multiple processors, and/or cluster of computers.

As shown in FIG. 2, position calculator 202 receives as an input an attempted order 206 to buy or sell a trading strategy. It should be understood that the attempted order 206 may be received from a client device adapted to send orders to an electronic exchange. Trading decisions to send orders at the client device may be manual or automated. According to another embodiment, the attempted order 206 may be received from a server side automation device. In some operations, the server side automation device may be adapted to send orders to an electronic exchange on behalf of a user of a client device. Trading decisions at the server side automation device may be automated, but the device may be adapted for manual intervention as well.

A. Contract Position Calculations

Position calculator 202 is configured to group all legs of the trading strategy that include contracts corresponding to the same product. For example, if a trading strategy includes contracts corresponding to two different products, the legs including the contracts corresponding to the first product may be combined into a first group, while the legs including the contracts corresponding to the second product may be combined into a second group.

Once the legs are grouped based on their association with different products, position calculator 202 may determine long and short positions 208 to be created in relation to each contract in the group. The positions created in relation to each contract are based on order quantities of each contract in quoting and hedge orders to be entered in the grouped legs as well as a spread ratio associated with each leg. The positions created in relation to hedge orders are further separated into positions created with hedge orders including calendar month contracts (i.e., outfights) and hedge orders including exchange-provided spread contracts. According to one example embodiment, the following positions are determined for each contract in the grouped legs:
1. Quoting Long Position (“QL”)=an order quantity of a contract to be bought in a quoting leg;
2. Quoting Short Position (“QS”)=an order quantity of a contract to be sold in a quoting leg;
3. Outright Hedge Long Position (“OHL”)=an order quantity of a contract to be bought in a hedge leg including a calendar month contract;
4. Outright Hedge Short Position (“OHS”)=an order quantity of a contract to be sold in a hedge leg including a calendar month contract;
5. Spread Hedge Long Position (“SHL”)=an order quantity of a contract to be bought in a hedge leg including an exchange-provided spread contract;
6. Spread Hedge Short Position (“SHS”)=an order quantity of a contract to be sold in a hedge leg including an exchange-provided spread contract.

Position calculator 202 may determine various contract positions based on a spread ratio corresponding to each leg of a trading strategy and a desired order quantity of an attempted order. For example, assume that a first leg of a trading strategy includes a calendar month contract and has a spread ratio of “3.” Let's also assume that a desired order quantity of an attempted order is “2.” Assuming that the attempted order is a buy order, a quantity of “6” (“3”×“2”) would be bought for the contract in the first leg based on the spread ratio and the desired order quantity. Assuming that the first leg is the only leg being quoted, a “QL” position of “6” would be determined for the calendar month contract in relation to the first leg.

According to one embodiment, position calculator 202 may first determine contract positions created in relation to each leg. For example, if a leg is defined as a quoted leg, position calculator 102 may determine “QL” and “QS” positions for one or more contracts in the leg. If the same leg is also a hedge leg when another leg of the trading strategy is quoted, position calculator 102 will also determine “OHL,” “OHS,” “SHL,” and “SHS” positions for one or more contracts in the leg. The calculated positions corresponding to the same contract may then be added across all legs to determine the overall positions for the contract, such as the overall “QL,” “QS,” “OHL,” “OHS,” “SHL,” and “SHS.”

To further illustrate how position calculator 202 may determine contract positions in relation to each leg of a trading strategy, let's assume that an attempted order is to buy an order quantity of “1” of a trading strategy including an exchange provided spread contract (“MAR-JUN”) in Leg 1, a first calendar month contract (“MAR”) in Leg 2, and a second calendar month contract (“JUN”) in Leg 3. Let's also assume that all legs of the trading strategy are defined as quoting legs, and that the trading strategy has a spread ratio of “1,” “−1,” and “1.” The trading strategy may be represented as follows:
(MAR-JUN)×(-MAR)×(JUN)

Based on the spread ratio and the desired order quantity of the trading strategy, position calculator 202 may determine the following positions for “MAR” contract in “MAR-JUN” leg:
QL=1, QS=0, OHL=0, OHS=0, SHL=2, and SHS=0.
   When the trading tool quotes Leg1, the trading tool sends a quoting order to buy “(MAR-JUN)” in Leg1. Based on the quoting order, a quantity of “1” is bough in “MAR.” Thus, QL of “1” is created for “MAR” contract. According to the definition of the trading strategy, the trading tool is also quoting Legs 2 and 3. When the quoting order in Leg2 is filled, the trading tool sends a hedge order to buy “MAR-JUN” in Leg1. Based on the hedge order, a quantity of “1” is bought in “MAR.” Similarly, when the quoting order in Leg2 is filled, the trading tool sends a hedge order to buy “MAR-JUN” in Leg1. Based on the hedge order, a quantity of “1” is bought in “MAR.” Because Leg1 includes an exchange-provided spread contract, a hedge position created in “MAR” contract is a SHL position. Based on the two hedge orders in Leg1, SHL position is “2.”

Position calculator 202 may determine the following positions for “JUN” contract in Leg1:
QL=0, QS=1, OHL=0, OHS=0, SHL=0, and SHS=2.
   When the trading tool sends a quoting order to buy “MAR-JUN” in Leg1, a quantity of “1” is sold in “JUN,” and QS position of “1” is created for “JUN” contract. Then, SHS position of “2” is based on hedge orders that the trading tool sends in Leg1 when the quoting orders in Leg2 and Leg3 are filled.

The following positions may be determined for “MAR” contract in Leg2:
QL=0, QS=1, OHL=0, OHS=2, SHL=0, and SHS=0.
   When the trading tool sends a quoting order to sell “MAR” in Leg2, a quantity of “1” is sold in “MAR,” and QS position of “1” is created for “MAR” contract. When the quoting order in Leg1 is filled, the trading tool sends a hedge order to sell a quantity of “1” in “MAR” of Leg2. Similarly, when the quoting order in Leg2 is filled, the trading tool sends a hedge order to sell a quantity of “1” in “MAR” contract of Leg2. Because Leg2 includes a calendar month contract, OHS position of “2” is determined in “MAR” based on the hedge orders.

Finally, the following positions may be determined for “JUN” contract in Leg3:
QL=1, QS=0, OHL=2, OHS=0, SHL=0, and SHS=0.
   When the trading tool sends a quoting order to buy “JUN” in Leg3, a quantity of “1” is bought in “JUN,” and QL position of “1” is created for “JUN” contract. When the quoting order in Leg1 is filled, the trading tool sends a hedge order to buy a quantity of “1” in “JUN” in Leg3. Similarly, when the quoting order in Leg2 is filled, the trading tool sends a hedge order to buy a quantity of “1” in “JUN” contract in Leg3. Because Leg3 includes a calendar month contract, OHL position of “2” is determined in “JUN” based on the hedge orders.

Position calculator 202 may then determine the overall positions for each contract across the three legs of the trading strategy. Based on the “MAR” positions created in Leg1 and Leg2, the overall positions for “MAR” contract are:
QL=1, QS=1, OHL=0, OHS=2, SHL=2, and SHS=0.
   Then, the overall positions for “JUN” contract based on the “JUN” positions in Leg1 and Leg3 are:
QL=1, QS=1, OHL=2, OHS=0, SHL=0, and SHS=2.

B. Spread Reduction Factor

When a trading strategy includes a number of exchange-provided spread contracts, position calculator 202 may determine if any of the calculated spread hedge positions should be reduced by a spread reduction factor. According to one embodiment, the spread hedge positions may be reduced when one of the exchange-provided spread contracts may be canceled by contracts in exchange-provided spread contracts in other legs of the trading strategy. For example, assume that a trading strategy is defined as “(MAR-JUN)×2(JUN-SEP)×1(SEP-DEC).” Based on the definition of the trading strategy, position calculator 202 may determine that one unit of “(JUN-SEP)” in Leg2 is completely offset by “−JUN” in “MAR-JUN” of Leg1 and “SEP” in “SEP-DEC” of Leg3.

According to one embodiment, spreads that are reduced include mixed-sign exchange provided spreads that have a potential not to impact the product position. Such spreads include, for example, two-legged exchange provided spread contracts having the same leg ratio, such as (JUN-SEP) spread with the first leg being bought and the second leg being sold. Similarly, three-legged exchange-provided spread contracts having all legs corresponding to the same product, such as, for example, (JUN-2SEP+DEC) may have a potential not to impact the product position as the overall long product position created by JUN and DEC contracts may be offset by the short product position created by SEP contract.

Once it is determined that an exchange-provided spread contract in a leg of a trading strategy is completely offset, position calculator 202 may determine a value of a spread reduction factor to be applied to SHL and SHS contract positions determined in relation to the canceled exchange-provided spread contract. According to one embodiment, the value of the spread reduction factor is a minimum of (i) a leg ratio corresponding to the exchange-provided spread contract being canceled, and (ii) a leg ratio of other leg(s) that are used to offset the exchange-provided spread contract. Referring to the example above, the spread reduction factor would be “1,” as the leg ratios of the exchange-provided spread contracts that are used to cancel “(JUN-SEP)” are both “1.” The value of the spread reduction factor may then be used to reduce SHL and SHS positions determined for each contract in the leg that includes the canceled exchange-provided spread contract, here in “(JUN-SEP)” leg.

C. Maximum Long/Short Product Position Calculations

Once various positions created by contracts of a trading strategy order are calculated, product risk calculator 204 is programmed to determine a maximum long product position and a maximum short product position.

To determine a maximum long/short product position, product risk calculator 204 first determines a maximum long/short position in relation to each contract corresponding to the same product. According to one embodiment, two assumptions are made with respect to possible fills of orders to be entered for a trading strategy. First, it is assumed that only quoting orders and outright hedge orders are filled. Second, it is assumed that quoting orders, outright hedge orders, and spread hedge orders are filled. Based on the two assumptions, two maximum long positions are determined for each contract including a maximum outright long position and a maximum spread long position. Similarly, two maximum short positions are determined including a maximum outright short position and a maximum spread short position.

Product risk calculator 204 may determine a maximum outright long/short position for a contract by taking into account positions created in the contract by quoting orders and outright hedge orders of a trading strategy. As explained above, the offsetting logic is applied to determine the maximum positions for a contract based on positions created in one leg when the contract is being bought and positions created in another leg when the contract is being sold. For example, an outright hedge long position created in one leg of a trading strategy for a contract may be used to offset a quoting short position created in another leg of the trading strategy for the same contract. Similarly, an outright hedge short position created in one leg for a contract may be used to offset a quoting long position created in another leg of the trading strategy for the same contract.

The following equation may be used to determine a maximum long outright position for each contract:
Max Long Outright Position=Max (QL−QS+OHL, 0)

Spread risk position calculator 204 may use the following equation to determine a maximum short outright position for each contract:
Max Short Outright Position=Max (QS−QL+OHS, 0)

To determine a maximum long/short spread position, product risk calculator 204 takes into account positions that are created by quoting orders, outright hedge orders, and spread hedge orders. Positions created by spread hedge orders may be used to not only offset positions created by quoting orders, but also positions created by outright hedge orders and other spread hedge orders. The following equation may be used to determine a maximum long spread position for each contract:
Max Long Spread Position=Max (QL−QS+OHL+SHL−SHS, 0)

Using similar logic, product risk calculator 204 may use the following equation to determine a maximum short spread position for each contract:
Max Short Spread Position=Max (QS−QL+OHS+SHS−SHL, 0)

Once the maximum outright/spread positions are determined for each contract, a total maximum long/short outright position and a total maximum long/short spread position is determined across all contracts corresponding to the same product:
Total Max Long Outright Position=ΣMax Long Outright Position of Each Contract
Total Max Short Outright Position=ΣMax Short Outright Position of Each Contract
Total Max Long Spread Position=ΣMax Long Spread Position of Each Contract
Total Max Short Spread Position=ΣMax Short Spread Position of Each Contract

Using the calculated values, product risk calculator 204 may determine a maximum long product position and a maximum short product position using the following equations:

### Max Long Product Position

Max (Total Max Long Outright Position, Total Max Long Spread Position)

### Max Short Product Position

Max (Total Max Short Outright Position, Total Max Short Spread Position)

Once the max long/short product positions are determined, they are output by spread risk position calculator 204 as shown at 210 and 212.

FIG. 3 shows a limit module 300 for determining whether to execute a trading strategy of an attempted order based on one or more limits.

Limit module 300 may be part of a modular architecture. Alternatively, the functionality of limit module 300 may be programmed into an integrated architecture. Limit module 300 may reside on the same machine as the components of risk calculation system 200, or it may reside on a separate machine. Any type computing device such as those enumerated above with respect to risk calculation system 200 may be used to implement limit module 300.

Limit module 300 is programmed to receive maximum long/short product positions 302 and one or more limits 304 for determining whether to approve a trading strategy for execution and thus whether to send one or more orders for the trading strategy, reject an order, or modify an order to fit within the limits. Max long/short product positions 302 may include positions calculated for an attempted order by risk calculation system 200. It should be understood that limit module 300 may also receive max long/short product positions to be established by other types of attempted orders, such as an outright order to buy or sell a contract corresponding to a product having a position limit that is managed at the limit module 300.

It should be understood that limit module 300 may control maximum positions that can be established for various products. In such an embodiment, each product may be associated with one or more limits. As orders are sent, limit module 300 may determine a product position balance for each product. It should be understood that various limits may be set by a trader or a system administrator.

When limit module 300 receives a max long/short product position for an attempted order, it may determine whether there are applicable product limits. Limits might include sending the attempted order if the product position balance is less than the maximum product long or short position determined for the order, and refraining from sending the order if the product position balance is greater than the maximum product long or short position. Limit module 300 may be programmed to send a signal that indicates whether the attempted order should be sent or rejected, as shown at 306. If the attempted order is rejected, it is not sent to an electronic exchange. If desired, the rejected order may be deleted or queued for later use depending on how the system is programmed. Alternatively, the rejected order may be modified to meet the product limits. A modified order may be generated automatically. In such an embodiment, a user may be required to approve a modified order before it is sent to an electronic exchange. Alternatively, a user may create a modified order.

### III. Product Position Calculation Examples

(i) Three-Legged Spread, All Legs Quoting

To illustrate spread position calculations, let's refer back to the trading strategy described above: “(MAR-JUN)×(-MAR)×(JUN).” Let's assume that a desired order quantity of an attempted order to buy the trading strategy is “1,” and that all three legs of the trading strategy are quoting legs. As explained above, position calculator 202 may first determine various positions that may be created for each contract in relation to each leg of the trading strategy. The positions calculated for each contract in relation to Legs 1-3 of the trading strategy are shown in Table 2.

TABLE 2

| | | QL | QS | OHL | OHS | SHL | SHS |
|---|---|---|---|---|---|---|---|
| Leg 1 | MAR | 1 | 0 | 0 | 0 | 2 | 0 |
| | JUN | 0 | 1 | 0 | 0 | 0 | 2 |
| Leg 2 | MAR | 0 | 1 | 0 | 2 | 0 | 0 |
| Leg 3 | JUN | 1 | 0 | 2 | 0 | 0 | 0 |

The calculated positions for contracts in each leg of the trading strategy may then be used to determine total positions for each contract across all legs of the trading strategy. Table 3 shows total positions for each contract of the trading strategy.

TABLE 3

| | QL | QS | OHL | OHS | SHL | SHS |
|---|---|---|---|---|---|---|
| MAR | 1 | 1 | 0 | 2 | 2 | 0 |
| JUN | 1 | 1 | 2 | 0 | 0 | 2 |

Using equations described above, a maximum outright long position and a maximum outright short position may be calculated for “MAR” and “JUN” contracts:

### MAX Long Outright Positions

“MAR” contract: MAX [(1 QL−1 QS+0 OHL), 0]=0
“JUN” contract: MAX [(1 QL−1 QS+2 OHL), 0]=2

### MAX Short Outright Positions

“MAR” contract: MAX [(1 QS−1 QL+2 OHS), 0]=2
“JUN” contract: MAX [(1 QS−1 QL+0 OHS), 0]=0

Using equations described above, a maximum long spread position and a maximum short spread position may be determined for “MAR” and “JUN” contracts:

### MAX Long Spread Positions

“MAR” contract: MAX [(1 QL−1 QS+0 OHL+2 SHL−0 SHS), 0]=2
“JUN” contract: MAX [(1 QL−1 QS+2 OHL+0 SHL−2 SHS), 0]=0

### Max Short Spread Positions

“MAR” contract: MAX [(1 QS−1 QL+2 OHS+0 SHS−2 SHL), 0]=0
“JUN” contract: MAX [(1 QS−1 QL+0 OHS+2 SHS−0 SHL), 0]=2

Once the maximum outright/spread positions are determined for each contract, a total maximum outright long position and a total maximum long spread long position may be determined across the legs of the trading strategy:

### Total Maximum Long Outright Position

ΣMax Long Outright Position of Each Contract: (0 “MAR”+2 “JUN”)=2

### Total Max Long Spread Position

ΣMax Long Spread Position of Each Contract: (2 “MAR”+0 “JUN”)=2

The maximum long product position may then be determined as follows:

### Max Long Product Position

Max (Total Max Long Outright Position, Total Max Long Spread Position)=Max (2, 2)=2

Similarly, a total maximum outright short position and a total maximum short spread position may be determined across the legs of the trading strategy:

### Total Maximum Short Outright Position

ΣMax Short Outright Position of Each Contract: (2 “MAR”+0 “JUN”)=2

### Total Maximum Short Spread Position

ΣMax Long Spread Position of Each Contract: (0 “MAR”+2 “JUN”)=2

The maximum short product position may then be determined as follows:

### Max Short Product Position

Max (Total Max Short Outright Position, Total Max Short Spread Position)=Max (2, 2)=2

Based on the calculations above, the maximum long product position and the maximum short product position for the trading strategy are both “2.” As a comparison, using the previously existing methods that were simply adding positions created across all contracts of the same product, the maximum long and short product positions for the same trading strategy were both “6.” By recognizing the offsetting relationship between different orders of the trading strategy that share the same contract, the methods described herein result in more accurate calculations of maximum long and short product positions.

(ii) Three-Legged Spread with a Spread Reduction Factor

According to another example, assume that a trader configures a three-legged trading strategy that includes an exchange-provided spread contract in each of its legs. Let's also assume that all three legs are being quoted, a spread ratio is “1:1:1,” and a desired order quantity for the trading strategy is “1.” The exchange-provided spread contracts in the legs of the trading strategy include: (MAR-JUN) in Leg1, (JUN-SEP) in Leg2, and (SEP-DEC) in Leg3, with all contracts corresponding to the same product. Based on the definition of the trading strategy, the trading strategy may be represented as:
(MAR-JUN)×(JUN-SEP)×(SEP-DEC)

Using the methods described above, position calculator 202 may first determine that “(JUN-SEP)” exchange-provided spread contract in Leg2 of the trading strategy may be completely offsets by calendar month contracts in the exchange-provided spreads of Leg1 and Leg3 of the trading strategy. More specifically, “JUN” contract that is bought as part of “(JUN-SEP)” spread contract in Leg2 may be offset by “JUN” contract that is sold as part of “(MAR-JUN)” spread contract in Leg1. Similarly, “SEP” contract that is sold as part of “(JUN-SEP)” spread contract in Leg2 may be offset by “SEP” contract that is bought as part of “(SEP-DEC)” spread contract in Leg3.

Based on the spread ratios of Leg1 and Leg3, a spread reduction factor is set to “1,” i.e., Min (spread ratio of Leg 1, spread ratio of Leg 2, spread ratio of Leg3). The spread reduction factor may then be applied to spread hedge positions created by each hedge order in Leg2 of the trading strategy. Using the definition of the trading strategy, the first hedge order is generated to buy (JUN-SEP) spread contract in Leg2 upon detecting a fill of a quoting order in Leg1. Based on the first hedge order to buy (JUN-SEP) spread contract, SHL of “1” would be created in “JUN,” and SHS of “1” would be created in “SEP.” Applying the spread reduction factor, SHL and SHS would be reduced to “0.” Upon detecting a fill of a quoting order in Leg3, a second hedge order would be generated in Leg2. When the spread reduction factor is applied to spread hedge positions of the second hedge order, SHL and SHS are also reduced to “0.”

Using the methods described above, position calculator 202 may determine various positions that may be created for each contract in relation to each leg of a trading strategy. The positions calculated for each contract in relation to Legs 1-3 of the trading strategy are shown in Table 4.

TABLE 4

| | | QL | QS | OHL | OHS | SHL | SHS |
|---|---|---|---|---|---|---|---|
| Leg 1 | MAR | 1 | 0 | 0 | 0 | 2 | 0 |
| | JUN | 0 | 1 | 0 | 0 | 0 | 2 |
| Leg 2 | JUN | 1 | 0 | 0 | 0 | 0 | 0 |
| | SEP | 0 | 1 | 0 | 0 | 0 | 0 |
| Leg 3 | SEP | 1 | 0 | 0 | 0 | 2 | 0 |
| | DEC | 0 | 1 | 0 | 0 | 0 | 2 |

The calculated positions for contracts in each leg may then be used to determine total positions for each contract. Table 5 shows total positions for each contract of the trading strategy.

TABLE 5

| | QL | QS | OHL | OHS | SHL | SHS |
|---|---|---|---|---|---|---|
| MAR | 1 | 0 | 0 | 0 | 2 | 0 |
| JUN | 1 | 1 | 0 | 0 | 0 | 2 |
| SEP | 1 | 1 | 0 | 0 | 2 | 0 |
| DEC | 0 | 1 | 0 | 0 | 0 | 2 |

Using equations described above, a maximum long outright position and a maximum short outright position may be calculated for “MAR,” “JUN,” “SEP,” and “DEC” contracts:

### MAX Long Outright Positions

“MAR” contract: MAX [(1 QL−0 QS+0 OHL), 0]=1
“JUN” contract: MAX [(1QL−1 QS+0 OHL), 0]=0
“SEP” contract: MAX [(1QL−1 QS+0 OHL), 0]=0
“DEC” contract: MAX [(0QL−1 QS+0 OHL), 0]=0

### MAX Short Outright Positions

“MAR” contract: MAX [(0 QS−1 QL+0 OHS), 0]=0
“JUN” contract: MAX [(1 QS−1 QL+0 OHS), 0]=0
“SEP” contract: MAX [(1 QS−1 QL+0 OHS), 0]=0
“DEC” contract: MAX [(1 QS−0 QL+0 OHS), 0]=1

Using equations described above, a maximum long spread position and a max short spread position may be determined for each contract as follows:

### MAX Long Spread Positions

“MAR” contract: MAX [(1 QL−0 QS+0 OHL+2 SHL−0 SHS), 0]=3
“JUN” contract: MAX [(1 QL−1 QS+0 OHL+0 SHL−2 SHS), 0]=0
“SEP” contract: MAX [(1 QL−1 QS+0 OHL+2 SHL−0 SHS), 0]=2
“DEC” contract: MAX [(0 QL−1 QS+0 OHL+0 SHL−2 SHS), 0]=0

### Max Short Spread Positions

“MAR” contract: MAX [(0 QS−1 QL+0 OHS+0 SHS−2 SHL), 0]=0
“JUN” contract: MAX [(1 QS−1 QL+0 OHS+2 SHS−0 SHL), 0]=2
“SEP” contract: MAX [(1 QS−1 QL+0 OHS+0 SHS−2 SHL), 0]=0
“DEC” contract: MAX [(1 QS−0 QL+0 OHS+2 SHS−0 SHL), 0]=3

Once the maximum outright/spread positions are determined for each contract, a total maximum outright long position and a total maximum long spread position may be determined across all legs of the trading strategy:

### Total Max Long Outright Position

ΣMax Long Outright Position of Each Contract: (1“MAR”+0“JUN”+0“SEP”+0“DEC”)=1

### Total Max Long Spread Position

ΣMax Long Spread Position of Each Contract: (3“MAR”+0“JUN”+2“SEP”+0“DEC”)=5

The maximum long product position may determined as follows:

### Max Long Product Position

MAX (Total Max Outright Long, Total Max Spread Long)=Max (1,5)=5

Similarly, a total maximum short outright position and a total maximum short spread position may be determined across the legs of the trading strategy:

### Total Max Short Outright Position

ΣMax Short Outright Position of Each Contract: (0“MAR”+0“JUN”+0“SEP”+1“DEC”)=1

### Total Max Short Spread Position

ΣMax Short Spread Position of Each Contract: (0“MAR”+2“JUN”+0“SEP”+3“DEC”)=5

The maximum short product position may be determined as follows:

### Max Short Product Position

MAX (Total Max Short Outright Position, Total Max Short Spread Position)=MAX (1, 5)=5

Based on the calculations above, the maximum long product position and the maximum short product position for the trading strategy are both “5.”

(iii) Trading Strategies with Partially Disclosed Quantities

According to yet another embodiment, a user may specify a desired order quantity for a trading strategy, but only a portion of the desired order quantity may be submitted, or disclosed, to the market at a time. When the disclosed order quantity for the trading strategy is executed, a new order with a new disclosed quantity for the trading strategy may be generated. The process may continue until the trading strategy for the desired order quantity is executed or until a predefined condition, such as cancellation of the trading strategy, is detected. It should be understood that a disclosed quantity as well as a price level for each disclosed quantity of the trading strategy may be user defined or may be determined based on a formula.

To determine a maximum long/short product position for such an order, the system may determine two sets of maximum product positions, one for a disclosed quantity and one for an undisclosed quantity. The equations described above may be used to determine maximum product positions for the disclosed quantity. To determine maximum positions for the undisclosed quantity, the methods described herein determine maximum long and short positions based on fills of all orders to be entered for the disclosed quantity before the last order for the disclosed quantity is to be submitted. The positions calculated in relation to the undisclosed quantity may then be added to the positions calculated for the disclosed quantity.

Let's assume a trading strategy described above (MAR-JUN) (JUN-SEP) (SEP-DEC) has a desired order quantity of “5,” and a disclosed quantity of “1.” Using the methods described above, a maximum long product position of “5” and a maximum short product position of “5” are determined for the disclosed quantity of “1.” Because three legs are quoted in relation to the trading strategy, the disclosed quantity of “1” may result in 3 orders of the trading strategy getting filled, thus, leaving 2 additional orders to be submitted for the trading strategy, with each order having a disclosed quantity of “1.” Once it is determined that there are 2 remaining orders to be submitted in the trading strategy, maximum long and short positions are determined with respect to any spread orders to be filled before the final disclosed quantity is submitted. In the example provided herein, the maximum long and short positions are determined with respect to one order for the trading strategy with a disclosed quantity of “1.”

Table 6 illustrates undisclosed positions created for “MAR” by each quoting leg of the trading strategy. For example, when Leg1 is quoting, an undisclosed long position of “1” is created for “MAR” in Leg1. Then, when Leg2 and Leg3 are quoting, each hedge order in Leg1 creates an undisclosed long position of “1” in “MAR” contract.

TABLE 6

| | “Mar-Jun” | “Jun-Sep” | “Sep-Dec” |
|---|---|---|---|
| MAR-JUN Quoting | ULong Position = 1 | — | — |
| JUN-SEP Quoting | ULong Position = 1 | — | — |
| SEP-DEC Quoting | ULong Position = 1 | — | — |

Using the undisclosed positions, product risk calculator 204 may determine a net undisclosed long position or a net undisclosed short position for a contract in relation to each quoting order. According to one embodiment, a net undisclosed long position is determined if an undisclosed long position is higher than an undisclosed short position for the quoting order and its hedge orders. Otherwise, a net undisclosed short position may be calculated. Based on the values shown in Table 6, a net long undisclosed position for “MAR” contract in relation to each quoting order is “1.”

Product risk calculator 204 may then determine a maximum undisclosed long position for “MAR” by adding net long positions determined across all quoting orders. In this example, a max undisclosed long position for “MAR” is “3.”

Table 7 illustrates undisclosed positions created by each quoting order and its hedges for “JUN” contract.

TABLE 7

| | “Mar-Jun” | “Jun-Sep” | “Sep-Dec” |
|---|---|---|---|
| MAR-JUN | UShort Position = 1 | ULong Position = 1 | — |
| Quoting | | | |
| JUN-SEP | UShort Position = 1 | ULong Position = 1 | — |
| Quoting | | | |
| SEP-DEC | UShort Position = 1 | ULong Position = 1 | — |
| Quoting | | | |

For example, when Leg 1 is quoting, an undisclosed short position is created in “JUN” based on the quoting order to buy (MAR-JUN) spread contract in Leg1. The undisclosed short position of “1” is based on an undisclosed short quantity of “1” and a leg ratio of “1.” Then, when the quoting order in Leg1 is filled, a hedge order to buy (JUN-SEP) spread contract would be sent in Leg2, creating an undisclosed long quantity of “1” in Leg2 for “JUN.” Other values in Table 7 are determined using similar methods.

Based on the values shown in Table 7, a net long/short undisclosed position for “JUN” determined in relation to each quoting order is “0,” as the undisclosed long/short positions cancel each other with respect to each quoting order and its hedges. Thus, maximum undisclosed long/short positions for “JUN” are “0.”

Table 8 illustrates undisclosed positions created by each quoting order and its hedges for “SEP” contract.

TABLE 8

| | “Mar-Jun” | “Jun-Sep” | “Sep-Dec” |
|---|---|---|---|
| MAR-JUN | — | UShort Position = 1 | ULong Position = 1 |
| Quoting | | | |
| JUN-SEP | — | UShort Position = 1 | ULong Position = 1 |
| Quoting | | | |
| SEP-DEC | — | UShort Position = 1 | ULong Position = 1 |
| Quoting | | | |

Based on the values shown in Table 8, a net long/short undisclosed position for “SEP” determined in relation to each quoting order is “0,” as the undisclosed long/short positions cancel each other with respect to each quoting order. Thus, the max undisclosed long/short positions for “SEP” are “0.”

Table 9 illustrates undisclosed positions created by each quoting order and its hedges for “DEC” contract.

TABLE 9

| | “Mar-Jun” | “Jun-Sep” | “Sep-Dec” |
|---|---|---|---|
| MAR-JUN Quoting | — | — | UShort Position = 1 |
| JUN-SEP Quoting | — | — | UShort Position = 1 |
| SEP-DEC Quoting | — | — | UShort Position = 1 |

Using the undisclosed positions, product risk calculator 204 may determine a net undisclosed long position or a net undisclosed short position for each quoting order. Based on the values shown in Table 9, a net short undisclosed position for each quoting order is “1.” Product risk calculator 204 may then determine a maximum undisclosed short position for “SEP” by adding the net short positions determined across all quoting orders. In this example, a maximum undisclosed short position for “DEC” is “3.”

The maximum undisclosed long and short positions for various contracts of the order may then be accumulated to determine a total max undisclosed long/short position for the product. In this example, a total max undisclosed long position is “3” based on the max long position of “3” in MAR, “0” in JUN,” “0” in SEP, and “0” in DEC. Then, a total max undisclosed short position for the order is “3” based on the max short position of “0” in MAR, “0” in JUN, “0” in SEP, and “3” in DEC.

To determine a max long product position for the order, the maximum long positions for the disclosed and undisclosed quantities may be added. In the example presented herein, the maximum long and short product positions for the order are “8”.

It should be understood that one or more of the steps of the methods discussed above may be implemented alone or in combination in various forms in hardware, firmware, and/or as a set of instructions in software, for example. Certain embodiments may be provided as a set of instructions residing on a computer-readable medium, such as a memory, hard disk, CD-ROM, DVD, and/or EPROM for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims

1. (canceled)

2. A system comprising:
a computing device comprising a processor, the computing device including:
a position calculating component configured to receive an attempted order to buy or sell a trading strategy, wherein the trading strategy comprises an exchange-provided spread in a first leg and a first contract in a second leg, the exchange provided spread comprising the first contract and a second contract of the same product, wherein the first contract in the exchange-provided spread is for a first side comprising one of a bid side and an ask side, and wherein the first contract in the second leg is for a second side that is opposite from the first side;
wherein the position calculating component is configured to determine a first maximum long outright position and a first maximum short outright position for the first contract based on a quoting long position and a quoting short position for the first contract in the first leg and the second leg, and further based on a long outright hedge position and a short outright hedge position for the first contract in the second leg, wherein the outright hedge long position reduces the quoting short position when the first maximum long outright position is calculated, and wherein the outright hedge short position reduces the quoting long position when the first maximum short outright position is calculated;
wherein the position calculating component is configured to determine a first maximum long spread position and a first maximum short spread position for the first contract based on the quoting long position, the quoting short position, the long outright hedge position, the short outright hedge position, a spread hedge long position and a spread hedge short position for the first contract in the first leg and the second leg, wherein the spread hedge short position reduces the quoting long position, the long outright hedge position, and the spread hedge long position when the first maximum long spread position is calculated, and wherein the spread hedge long position reduces the quoting short position, the short outright hedge position, and the spread hedge short position when the first maximum short spread position is calculated;
a product risk calculating component configured to determine a maximum long product position based on the first maximum outright long position and the first maximum spread long position, and further to determine a maximum short product position based on the first maximum outright short position and the first maximum spread short position;
a limit component configured to compare the maximum long product position and the maximum short product position to a product position balance associated with the product;
an order generator component configured to generate at least one order in the first leg or the second leg of the trading strategy based on current market conditions in at least one of the exchange-provided spread of the first leg and the first contract of the second leg; and
an order sending component configured to send the at least one order in the first leg or the second leg of the trading strategy to an electronic exchange when the maximum long product position and the maximum short product position do not exceed the product position balance.

3. The system of claim 2, wherein the first leg and the second leg are being quoted.

4. The system of claim 2, wherein the first maximum long outright position is determined based on the following relationship:
maximum of [(quoting long position−quoting short position+outright hedge long position),0].

5. The system of claim 2, wherein the first maximum short outright position is determined based on the following relationship:
maximum of [(quoting short position−quoting long position+outright hedge short position),0].

6. The system of claim 2, wherein the first maximum long spread position is determined based on the following relationship:
maximum of [(quoting long position−quoting short position+outright hedge long position+spread hedge long position−spread hedge short position),0].

7. The system of claim 2, wherein the first maximum short spread position is determined based on the following relationship:
maximum of [(quoting short position−quoting long position+outright hedge short position+spread hedge short position−spread hedge long position),0].

8. The system of claim 2, wherein the position calculating component is further configured to:
determine a total maximum long outright position based on maximum long outright positions for each of the first contract and the second contract; and
determine a total maximum long spread position based maximum long spread positions for each of the first contract and the second contract.

9. The system of claim 8, wherein the total maximum long outright position is determined based on the following relationship:
Σ(maximum long outright position of each contract).

10. The system of claim 8, wherein the total maximum long spread position is determined based on the following relationship:
Σ(maximum long spread position of each contract).

11. The system of claim 8, wherein the maximum long product position is determined based on the total maximum long outright position and the total maximum long spread position.

12. The system of claim 11, wherein the maximum long product position is determined based on the following relationship:
maximum of (total maximum long outright position, total maximum long spread position).

13. The system of claim 2, wherein the position calculating component is further configured to:
determine a total maximum short outright position based on maximum short outright positions for each of the first contract and the second contract; and
determine a total maximum short spread position based maximum short spread positions for each of the first contract and the second contract.

14. The system of claim 13, wherein the total maximum short outright position is determined based on the following relationship:
Σ(maximum short outright position of each contract).

15. The system of claim 14, wherein the total maximum short spread position is determined based on the following relationship:
Σ(maximum short spread position of each contract).

16. The system of claim 13, wherein the maximum short product position is determined based on the total maximum short outright position and the total maximum short spread position.

17. The system of claim 16, wherein the maximum short product position is determined based on the following relationship:
maximum of (total maximum short outright position, total maximum short spread position).

18. The system of claim 2, wherein the trading strategy comprises a spread trading strategy.

19. The system of claim 2, wherein the position calculating component is further configured to:
determine a second maximum long outright position and a second maximum short outright position for the second contract based on a quoting long position and a quoting short position to be created for the second contract in the first leg, and further based on a long outright hedge position and a short outright hedge position to be created for the second contract in the first leg; and
determine a second maximum long spread position and a second maximum short spread position for the second contract based on the quoting long position, the quoting short position, the long outright hedge position, the short outright hedge position, a spread hedge long position and a spread hedge short position to be created in the first leg.

20. The system of claim 19, wherein the maximum long product position is further based on the second maximum outright long position and the second maximum spread long position, and wherein the maximum short product position is further based on the second maximum outright short position and the second maximum spread short position.
